(19) United States
(12) Patent Application Publication
(10) Pub. No.: US 2026/0101852 A1
(43) Pub. Date: Apr. 16, 2026

(54) PLANT POT ASSEMBLY

(71) Applicant: SIMPLE SOLUTIONS, LLC, Derry, NH (US)

(72) Inventor: David Apostoloff, Derry, NH (US)

(21) Appl. No.: 18/911,785

(22) Filed: Oct. 10, 2024

(51) Int. Cl. A01G 9/02

(52) U.S. Cl. CPC A01G 9/0302

(57) ABSTRACT

A plant pot assembly includes a hollow outer body having a frustoconical side wall and an open upper end, a hollow inner body having a frustoconical side wall and an open upper end, the inner body configured to be removably rotatably disposed within the outer body with the side wall of the inner body engaging the side wall of the outer body, and apertures defined in the side walls of the inner and outer bodies, rotation of the inner body to a first position within the outer body causing the apertures in the side wall of the inner body to align with the apertures in the side wall of the outer body, rotation of the inner body to a second position within the outer body causing the apertures in the side wall of the inner body to be blocked by solid portions of the side wall of the outer body.

### FIELD OF TECHNOLOGY

Aspects and embodiments disclosed herein are generally related to plant pot assemblies for housing and growing plants.

### SUMMARY

In accordance with one aspect, there is provided a plant pot assembly. The plant pot assembly includes a hollow outer body having a substantially frustoconical side wall and an open upper end, a hollow inner body having a substantially frustoconical side wall and an open upper end, the inner body being configured to be removably rotatably disposed within the outer body such that outer surfaces of the side wall of the inner body engage inner surfaces of the side wall of the outer body, and one or more apertures defined in each of the side wall of the inner body and the side wall of the outer body, rotation of the inner body to a first position within the outer body causing the one or more apertures in the side wall of the inner body to align with the one or more apertures in the side wall of the outer body, rotation of the inner body to a second position within the outer body causing the one or more apertures in the side wall of the inner body to be blocked by one or more solid portions of the side wall of the outer body.

In some embodiments, each of the inner body and outer body further includes bottom walls each including one or more apertures, the one or more apertures in the bottom wall of the inner body being aligned with the one or more apertures in the bottom wall of the outer body when the inner body is disposed in the first position within the outer body, the one or more apertures in the bottom wall of the inner body being misaligned with the one or more apertures in the bottom wall of the outer body when the inner body is disposed in the second position within the outer body.

In some embodiments, the plant pot assembly further comprises a ring coupled to the bottom wall of the outer body, the ring circumscribing the one or more apertures in the bottom wall of the outer body.

In some embodiments, the plant pot assembly further comprises one or more fins coupled to and extending outward from an outer surface of the side wall of the outer body.

In some embodiments, the one or more fins are coupled to and extend outward from the one or more solid portions of the side wall of the outer body.

In some embodiments, the one or more fins include lower edges coupled to an upper surface of the ring.

In some embodiments, the lower edges of the one or more fins terminate at an outer edge of the ring.

In some embodiments, the bottom wall of the inner body includes one or more lower portions and one or more upper portions disposed at a height above the one or more lower portions.

In some embodiments, the bottom wall of the upper body includes one or more lower portions and one or more upper portions disposed at a height above the one or more lower portions.

In some embodiments, the one or more upper portions of the bottom wall of the inner body align with the one or more upper portions of the wall of the outer body when the inner body is disposed in the second position within the outer body.

In some embodiments, the plant pot assembly further comprises a ring coupled to and circumscribing a lower portion of the side wall of the outer body.

In some embodiments, the plant pot assembly further comprises a first indicator mark on an upper external portion of the side wall of the outer body and a second indicator mark on an upper external portion of the side wall of the inner body, relative positioning of the first indicator mark relative to the second indicator mark providing an indication of positioning of the one or more apertures in the side wall of the inner body relative to the one or more apertures in the side wall of the outer body.

In some embodiments, an upper end of the side wall of the inner body extends above an upper end of the side wall of the outer body when the inner body is disposed within the outer body.

In accordance with another aspect, there is provided a method of installing a plant pot assembly. The method comprises installing a hollow outer body within a hole created in ground material, the outer body including a substantially frustoconical side wall and an open upper end, the side wall of the outer body having one or more apertures defined therein, installing a plant in a hollow inner body, the inner body including a substantially frustoconical side wall and an open upper end, the side wall of the inner body having one or more apertures defined therein, the inner body being configured to be removably rotatably disposed within the outer body such that outer surfaces of the side wall of the inner body engage inner surfaces of the side wall of the outer body, positioning the inner body within the outer body, rotating the inner body to a first position within the outer body causing the one or more apertures in the side wall of the inner body to align with the one or more apertures in the side wall of the outer body, and rotating the inner body to a second position within the outer body causing the one or more apertures in the side wall of the inner body to be blocked by one or more solid portions of the side wall of the outer body.

In some embodiments, rotating the inner body to the second position within the outer body causes roots of the plant passing through the one or more apertures in the side wall of the inner body and the one or more apertures in the side wall of the outer body to be cut.

In some embodiments, the method further comprises removing the inner body from the outer body with the plant disposed in the inner body.

In some embodiments, the method further comprises placing the inner body within a second outer body.

In some embodiments, the method further comprises placing a second inner body including a second plant within the outer body.

In some embodiments, installing the outer body further includes at least partially burying the outer body in a ground material that is not conducive to the growth of plants.

In some embodiments, installing the outer body further includes at least partially burying the outer body in one of soil, gravel, or rocks.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of any particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 is an exploded isometric view of an embodiment of a plant pot assembly;

FIG. 2A is an isometric view of the embodiment of the plant pot assembly of FIG. 1 in an assembled configuration with the inner body in a first rotational position relative to the outer body;

FIG. 2B is an isometric view of the embodiment of the plant pot assembly of FIG. 1 in an assembled configuration with the inner body in a second rotational position relative to the outer body;

FIG. 3 is a top plan view of the inner body of an embodiment of a plant pot assembly;

FIG. 4 is a top plan view of the outer body of an embodiment of a plant pot assembly; and

FIG. 5 is a flowchart of a method of installing an embodiment of a plant pot assembly as disclosed herein.

### DETAILED DESCRIPTION

Aspects and embodiments discussed herein are not limited in application to the details of construction and the arrangement of components set forth in the following description or illustrated in the accompanying drawings. The disclosed aspects and embodiments are capable of implementation in other embodiments and of being practiced or of being carried out in various ways. Examples of specific implementations are provided herein for illustrative purposes only and are not intended to be limiting. In particular, acts, components, elements, and features discussed in connection with any one or more examples are not intended to be excluded from a similar role in any other examples.

Also, the phraseology and terminology used herein is for the purpose of description and should not be regarded as limiting. Any references to examples, embodiments, components, elements, or acts of the aspects herein referred to in the singular may also embrace embodiments including a plurality, and any references in plural to any embodiment, component, element, or act herein may also embrace embodiments including only a singularity. References in the singular or plural form are not intended to limit the presently disclosed aspects or embodiments, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms.

Property owners, both residential and commercial, often use annual flowers and other plants to decorate their property. To do so, the property owners will often plant flowers each year, often in the same location, and may change the type of flower during the year based on the season. For example, summer flowers may be replaced in the Fall with Chrysanthemums or other Fall flowers. The planting of flowers can be quite time consuming as typically, each plant must be individually planted in the soil, which requires digging new holes each season as well as digging holes to replace one flower with another each season The planting process can be particularly difficult in flower beds having ornamental stones rather than traditional mulch. Moving the stones to dig holes for the plants adds additional time and effort to the planting process. Also, when replacing plants in beds having stones, when one plant is removed, the stones will typically fill the plant's hole and need to be removed prior to planting a second plant in the hole. Traditional flower pots, although providing for movement of potted plants from one location to another, do not provide for easily swapping out plants that have been planted directly in the ground. Aspects and embodiments disclosed herein may address at least this disadvantage of conventional planting techniques.

In accordance with some aspect and embodiments, a plant pot assembly includes an outer body that may be buried in the ground. The plant pot assembly may further include an inner body for housing soil and a plant that may be removably inserted into the outer body, which may give the appearance of the plant being planted directly in the ground. Both the inner and outer bodies may be substantially frustoconical in shape, similar to traditional plant pots, with the inner body being sized to snugly fit within the outer body such that outer walls of the inner body engage inner walls of the outer body. The inner body may have a height greater than the outer body so even if the outer body is fully buried an upper edge of the inner body may extend above ground level so the inner body may be manipulated by a user while the inner body is disposed within the outer body.

The outer body may include retention features such as protruding fins, rings, or other such structures which cause the outer body to resist rotation or removal from its position in the ground. The inner body may be able to at least partially rotate within the outer body. The inner body and outer body may each include side walls having one or more apertures. Rotation of the inner body relative to the outer body may control the degree to which the apertures in the side walls of the inner and outer bodies align.

If a user desires to relocate a plant growing within an inner body of a plant pot assembly as disclosed herein from a first outer body to second outer body at a different location, one may remove the inner body from the first outer body and install it in the second outer body. In some instances, if a plant has been growing for some time within a plant pot assembly as disclosed herein, roots of the plant may have grown through apertures in walls of the inner and outer bodies. In some embodiments, the walls of the inner and outer bodies are sufficiently thin, or edges of apertures in the walls of one or both of the inner and outer bodies may be sufficiently sharp, that rotation of the inner body relative to the outer body to cause the apertures in the walls of the inner and outer bodies to be misaligned may sever the roots of the plant that pass through the apertures and free the inner body and plant from the outer body.

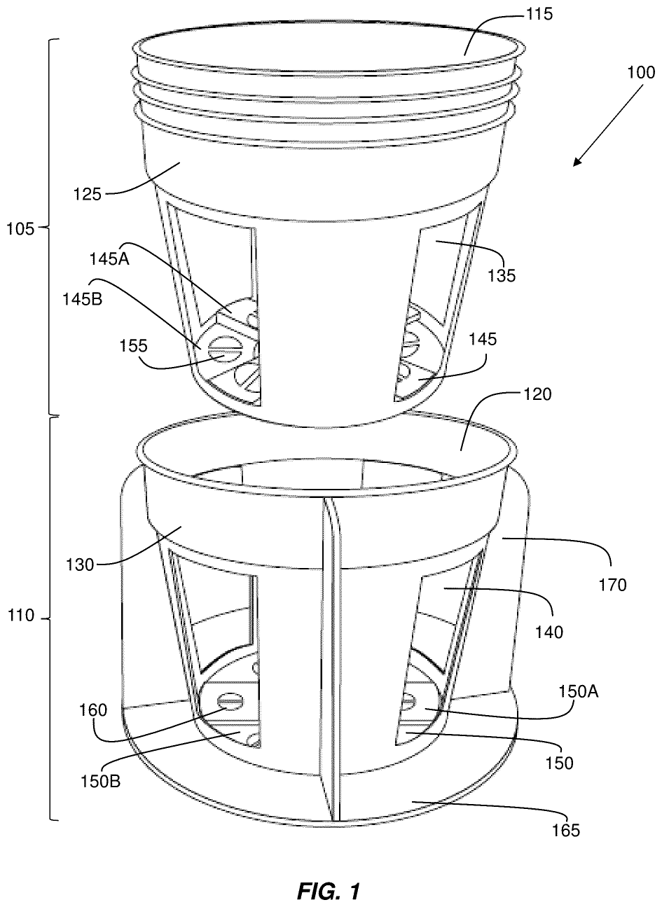

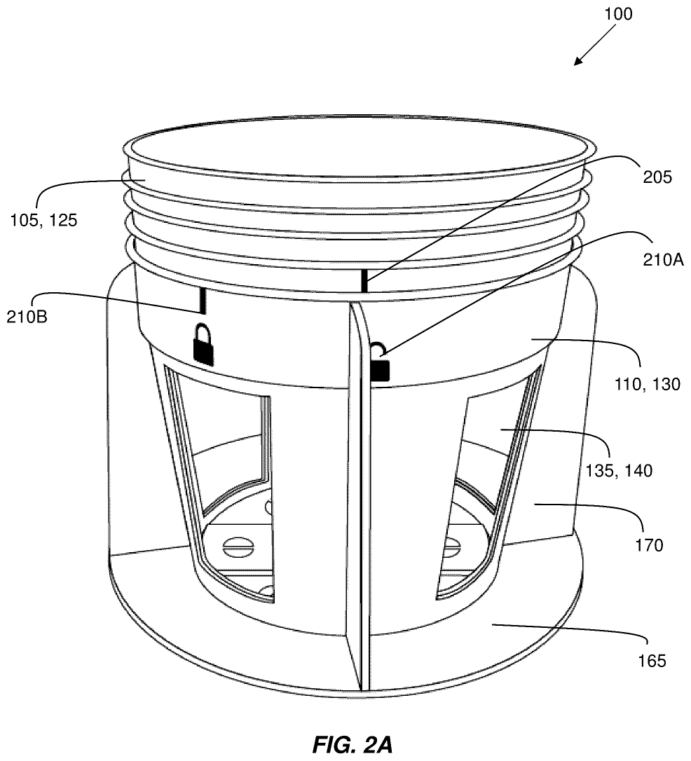

One example of a plant pot assembly is indicated generally at 100 in an exploded view in FIG. 1. The plant pot assembly includes a hollow inner body 105 and a hollow outer body 110. In use, the inner body 105 may be filled with soil and may include one or more plants and the outer body 110 may be at least partially buried in the ground, for example, in dirt, sand, gravel, rocks, etc. Each of the inner body 105 and the outer body 110 have open upper ends 115, 120 and frustoconical, or substantially frustoconical, sidewalls 125, 130, respectively. The sidewalls 125, 130 may be considered “substantially frustoconical” because there may be jogs between upper portions and lower portions of the sidewalls 125, 130 so that the sidewalls 125, 130 are not entirely smooth or continuous along their vertical extent. The inner body 105 is sized and shaped to be removably inserted into the lower body 110 as illustrated in isometric views in FIGS. 2A and 2B. When the inner body 105 is disposed within the outer body 110, the outer surface of the sidewall 125 of the inner body 105 may engage the inner surface of the sidewall 130 of the outer body 110. The outer surface of the sidewall 125 of the inner body 105 and inner surface of the sidewall 130 of the outer body 110 are sufficiently smooth such that the inner body 105 may be easily rotated by hand relative to the outer body 110 when the inner body 105 is disposed within the outer body 110.

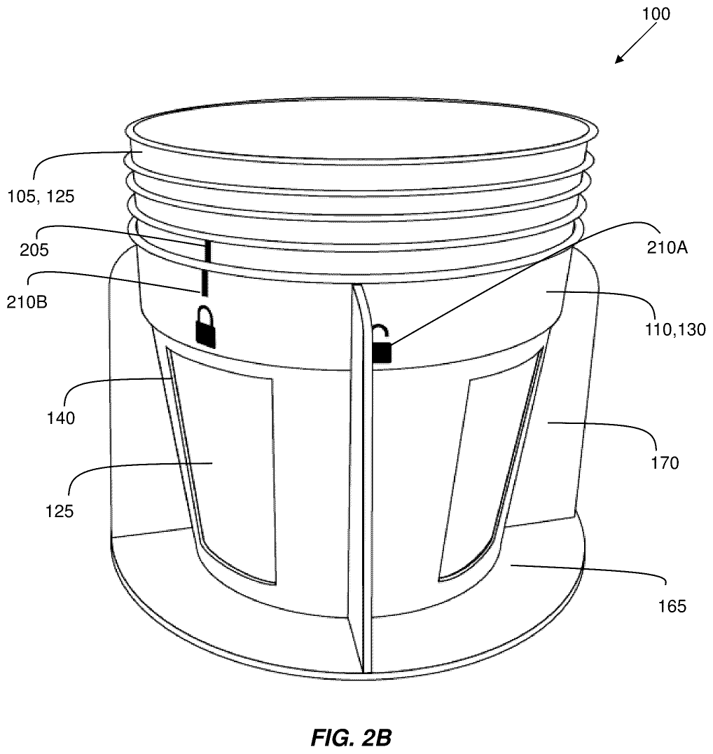

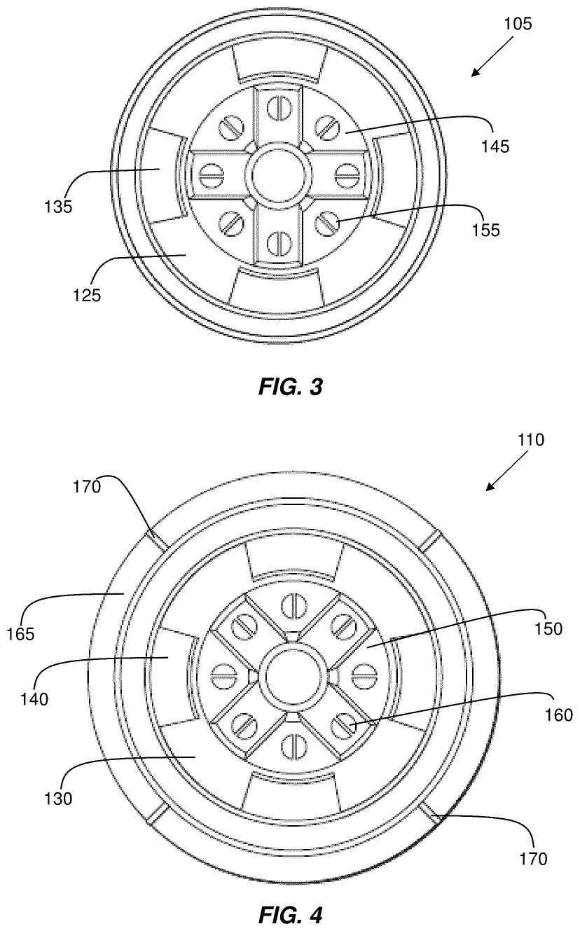

The side wall 125 of the inner body 105 includes at least one aperture 135 and the sidewall 130 of the outer body 110 includes at least one aperture 140. In the embodiment shown in FIG. 1, and as more clearly seen in the top plan views of the inner body 105 in FIG. 3 and of the outer body 110 in FIG. 4, there are four apertures 135, 140 defined in the side walls 125, 130 of both the inner body 105 and outer body 110, respectively. Embodiments of the plant pot assembly 100 are not limited to four apertures 135, 140 in the side walls 125, 130 of the inner body 105 and outer body 110 and other embodiments may include a fewer or a greater number of apertures 135, 140. In general, however, there are an equal number of apertures 135, 140 defined in the side walls 125, 130 of both the inner body 105 and outer body 110, respectively. The apertures 135, 140 may be evenly distributed about the circumferences of the side walls 125, 130 of the inner body 105 and outer body 110. Although in some embodiments there may be as few as a single aperture 135, 140 in the side walls 125, 130 of the inner body 105 and outer body 110 the apertures 135, 140 will be referred to herein in the plural.

Rotation of the inner body 105 within the outer body 110 into a first position may cause the apertures 135 in the side wall 125 of the inner body 105 to be aligned with the apertures 140 in the side wall 130 of the outer body 110. (See FIG. 2A.) In some embodiments the apertures 135, 140 may have identical shapes and sizes such that when aligned, the respective edges of the apertures 135, 140 overlie each other. In other embodiments, the apertures 135, 140 may have different sizes and/or shapes from one another.

Rotation of the inner body 105 relative to the outer body 110 away from the position at which the apertures 135, 140 are fully aligned may cause the apertures 135, 140 to be only partially aligned. Additional rotation of the inner body 105 relative to the outer body 110 into a second position may cause the apertures 135, 140 to be fully misaligned such that solid portions of the side wall 130 of the outer body 110 fully block the apertures 135 in the sidewall 125 of the inner body 105, and solid portions of the side wall 125 of the inner body 105 fully block the apertures 140 in the sidewall 130 of the outer body 110. (See FIG. 2B). In some embodiments, the first rotational position in which the apertures 135, 140 are fully aligned may be offset by about 45° relative to the second rotational position in which the apertures 135, 140 are fully blocked by solid portions of the sidewalls 125, 130.

In some embodiments markings 205, 210A, 210B on the upper portions of side walls 125, 130 of the inner and outer bodies 105, 110 may provide a visual indication of the relative alignment of the apertures 135, 140. The markings 205, 210A, 210B may be drawn on the outer surfaces of the side walls 125, 130 or may be in the form of indentations, recesses, or other tactile features defined in the outer surfaces of the side walls 125, 130. In FIGS. 2A and 2B marking 205 is in the form of a line printed on the upper portion of the side wall 125 of the inner body, marking 210A is in the form of an image of an open lock printed on the upper portion the side wall 130 of the outer body 110, and marking 210B is in the form of a line and an image of a closed lock printed on the upper portion the side wall 130 of the outer body 110 at a position offset by 45° from marking 210A. As shown in FIG. 2A, when marker 205 is aligned with marker 210A this may be an indication that the apertures 135, 140 are aligned and form openings through the side walls 125, 130 of the inner and outer bodies 105, 110. When marker 205 is aligned with marker 210B as shown in FIG. 2B this may indicate that the apertures 135, 140 are blocked. As shown in FIG. 2B the aperture 140 is blocked by a solid portion of the side wall 125 of the inner body 105. In some embodiments, such as illustrated in FIGS. 2A and 2B, the upper end of the side wall 125 of the inner body 105 extends above an upper end of the side wall 130 of the outer body 110 when the inner body 105 is disposed within the outer body 110 to ensure that the marker(s) 205 on the upper portion of the side wall of 125 of the inner body 105 is/are not obscured by the side wall 130 of the outer body 110.

Each of the inner body 105 and the outer body 110 have bottom walls indicated at 145 and 150, respectively. The bottom wall 145 may include upper portions 145A and lower portions 145B. The upper portions 145A may be disposed at a height above a height at which the lower portions 145B are disposed. The bottom wall 150 may include upper portions 150A and lower portions 150B. The upper portions 150A may be disposed at a height above a height at which the lower portions 150B are disposed. The upper portions 145A of the bottom wall 145 of the inner body 105 may align with the upper portions 150A of the wall 150 of the outer body 110 when the inner body 105 is disposed in the second rotational position within the outer body 110.

In some embodiments, there are one or more apertures 155, 160 defined in the respective bottom walls 145, 150. The apertures 155, 160 may be evenly distributed about the circumferences of the bottom walls 145, 150. The one or more apertures 155, 160 may be defined in the upper portions 145A, 155A and/or the lower portions 145B, 155B of the bottom walls 145, 155. As seen most easily in FIGS. 3 and 4 there may be eight of each of apertures 155, 160. Embodiments disclosed herein are not limited to a particular number of apertures 155, 160 although there may generally be the same number of apertures 155 as the number of apertures 160. In the first position discussed above in which the apertures 135, 140 in the side walls 125, 130 of the inner and outer bodies 105, 100 are fully aligned the apertures 155, 160 may also be fully aligned. Rotation of the inner body 105 relative to the outer body 110 may displace the apertures 155, 160 from alignment with each other until, in the second position in which the apertures 135, 140 in the side walls 125, 130 of the inner and outer bodies 105, 100 are fully misaligned and blocked, the apertures 155 may face solid portions of the bottom wall 150 of the outer body 110 and the apertures 160 may face solid portions of the bottom wall 145 of the inner body 105.

The outer body 110 includes features to help secure the outer body 110 in place when at least partially buried and to help prevent the outer body 110 from rotating when one rotates the inner body 105 within it. One of these features is a ring 165 coupled to the bottom wall 150 of the outer body 110. The ring 165 is coupled to the bottom wall 150 at a position radially outside of the apertures 160 and circumscribes the apertures 160. The ring 165 helps to prevent the outer body 110 from being pulled up out of the ground. In alternative embodiments, the ring 165 may circumscribe portions of the side wall 130 of the outer body 110 in addition to or as an alternative to being secured to the bottom wall 150. The ring 165 would typically not cover portions of any of the apertures 140, 160 but in some embodiments it may.

The outer body 110 also includes one or more fins 170 coupled to and extending outward from the outer surface of the side wall 130 of the outer body 110. There may be four fins 170 equally spaced about the circumference of the side wall 130 of the outer body 110, for example, adjacent fins 170 may be separated by angles of 90°from each other. Other embodiments may include a fewer number or a greater number of fins 170. The fins 170 help prevent the outer body 110 from rotating when one rotates the inner body 105 within the outer body 110 so that one may rotate the inner body 105 relative to the outer body 110 to position the various apertures 135, 140 and 155, 160 relative to one another. The fins 170 may have generally vertically oriented outer edges with curved portions at their upper ends as illustrated, however, may have other shapes in different embodiments. The lower edges of the fins 170 may be coupled to the upper surface of the ring 165 and may terminate at the outer edge of the ring 165. The fins 170 may extend outward from solid portions of the outer surface of the side wall 130 of the outer body 110 and not cover any portion of apertures 140, although in some embodiments one or more of the fins 170 may cover one or more portions of one or more of the apertures 140.

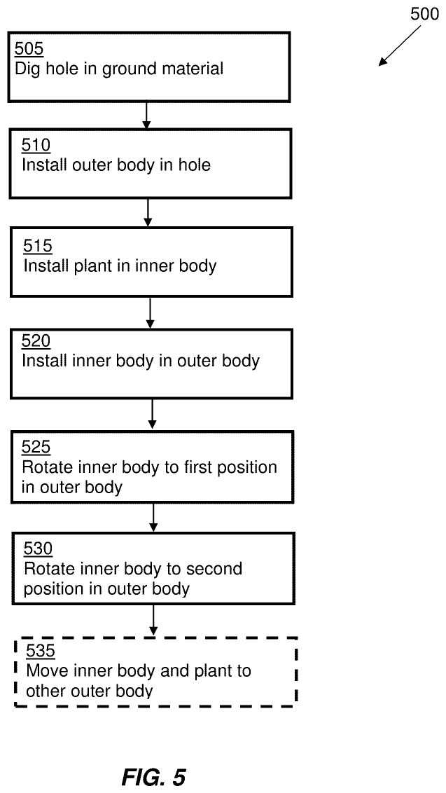

Also disclosed herein is a method of installing a plant pot assembly as disclosed herein. A flow chart of an example of this method is shown in FIG. 5 indicated generally at 500. In a first act 505 one may dig a hole in ground material, for example, in soil, gravel, sand, rocks, or other forms of ground material. In a second act 510 one may install an outer body 110 as disclosed herein in the hole and at least partially fill in the hole so the outer body is at least partially buried. In this position, the outer body 110 is prevented from rotating because of the fins 170. In a following act 515 one may install a plant in an inner body 105 as disclosed herein. Installing the plant may include at least partially filling the inner body with an appropriate form of growth medium for the plant, for example, soil. In act 520 one may position the inner body 105 within the outer body 110. In some embodiments the order of acts 515 and 520 may be reversed. One may first position the inner body 105 within the outer body 110 and then install the plant and growth medium in the inner body 105. This may help prevent the growth medium from escaping through the apertures 135, 155 in the inner body 105 before the inner body 105 is placed in the outer body 110. In act 525 one may rotate the inner body 105 to a first position within the outer body 110 to cause one or more apertures 135 in the side wall 125 of the inner body 105 to align with one or more apertures 140 in the side wall 130 of the outer body 110. In act 530 one may rotate the inner body 105 to a second position within the outer body 110 to cause the one or more apertures 135 in the side wall 125 of the inner body 105 to be blocked by one or more solid portions of the side wall 130 of the outer body 110. The order of acts 525 and 530 may be reversed or these acts repeated as desired. If a plant has been growing in a plant pot assembly 100 as disclosed herein for a long enough period for roots to grow out through the apertures in the inner and outer bodies 105, 110 rotating the inner body 105 to the second position within the outer body 110 may cause the roots of the plant passing through the one or more apertures 135 in the side wall 125 of the inner body 105 and the one or more apertures 140 in the side wall 130 of the outer body 110 to be severed. This may provide for one to remove the inner body 105 from the outer body 110 with the plant disposed in the inner body 105 so that one may place the inner body 105 and plant within a second outer body 110 (optional act 535) and possibly replace the plant with another plant disposed in another inner body 105.

In at least some embodiments described above, flowers and other plants are described as being planted in flower beds. In other embodiments, flowers and other plants can be planted in areas other than flower beds, and in addition, at least some embodiments may be used with vegetables planted in a vegetable garden.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. A plant pot assembly comprising:
a hollow outer body having a substantially frustoconical side wall and an open upper end;
a hollow inner body having a substantially frustoconical side wall and an open upper end, the inner body being configured to be removably rotatably disposed within the outer body such that outer surfaces of the side wall of the inner body engage inner surfaces of the side wall of the outer body; and
one or more apertures defined in each of the side wall of the inner body and the side wall of the outer body, rotation of the inner body to a first position within the outer body causing the one or more apertures in the side wall of the inner body to align with the one or more apertures in the side wall of the outer body, rotation of the inner body to a second position within the outer body causing the one or more apertures in the side wall of the inner body to be blocked by one or more solid portions of the side wall of the outer body.

2. The plant pot assembly of claim 1, wherein each of the inner body and outer body further includes bottom walls each including one or more apertures, the one or more apertures in the bottom wall of the inner body being aligned with the one or more apertures in the bottom wall of the outer body when the inner body is disposed in the first position within the outer body, the one or more apertures in the bottom wall of the inner body being misaligned with the one or more apertures in the bottom wall of the outer body when the inner body is disposed in the second position within the outer body.

3. The plant pot assembly of claim 2, further comprising a ring coupled to the bottom wall of the outer body, the ring circumscribing the one or more apertures in the bottom wall of the outer body.

4. The plant pot assembly of claim 3, further comprising one or more fins coupled to and extending outward from an outer surface of the side wall of the outer body.

5. The plant pot assembly of claim 4, wherein the one or more fins are coupled to and extend outward from the one or more solid portions of the side wall of the outer body.

6. The plant pot assembly of claim 4, wherein the one or more fins include lower edges coupled to an upper surface of the ring.

7. The plant pot assembly of claim 6, wherein the lower edges of the one or more fins terminate at an outer edge of the ring.

8. The plant pot assembly of claim 2, wherein the bottom wall of the inner body includes one or more lower portions and one or more upper portions disposed at a height above the one or more lower portions.

9. The plant pot assembly of claim 2, wherein the bottom wall of the upper body includes one or more lower portions and one or more upper portions disposed at a height above the one or more lower portions.

10. The plant pot assembly of claim 9, wherein the one or more upper portions of the bottom wall of the inner body align with the one or more upper portions of the wall of the outer body when the inner body is disposed in the second position within the outer body.

11. The plant pot assembly of claim 1, further comprising a ring coupled to and circumscribing a lower portion of the side wall of the outer body.

12. The plant pot assembly of claim 1, further comprising a first indicator mark on an upper external portion of the side wall of the outer body and a second indicator mark on an upper external portion of the side wall of the inner body, relative positioning of the first indicator mark relative to the second indicator mark providing an indication of positioning of the one or more apertures in the side wall of the inner body relative to the one or more apertures in the side wall of the outer body.

13. The plant pot assembly of claim 1, wherein an upper end of the side wall of the inner body extends above an upper end of the side wall of the outer body when the inner body is disposed within the outer body.

14. A method of installing a plant pot assembly, the method comprising:
installing a hollow outer body within a hole created in ground material, the outer body including a substantially frustoconical side wall and an open upper end, the side wall of the outer body having one or more apertures defined therein;
installing a plant in a hollow inner body, the inner body including a substantially frustoconical side wall and an open upper end, the side wall of the inner body having one or more apertures defined therein, the inner body being configured to be removably rotatably disposed within the outer body such that outer surfaces of the side wall of the inner body engage inner surfaces of the side wall of the outer body;
positioning the inner body within the outer body;
rotating the inner body to a first position within the outer body causing the one or more apertures in the side wall of the inner body to align with the one or more apertures in the side wall of the outer body; and
rotating the inner body to a second position within the outer body causing the one or more apertures in the side wall of the inner body to be blocked by one or more solid portions of the side wall of the outer body.

15. The method of claim 14, wherein rotating the inner body to the second position within the outer body causes roots of the plant passing through the one or more apertures in the side wall of the inner body and the one or more apertures in the side wall of the outer body to be cut.

16. The method of claim 15, further comprising removing the inner body from the outer body with the plant disposed in the inner body.

17. The method of claim 16, further comprising placing the inner body within a second outer body.

18. The method of claim 16, further comprising placing a second inner body including a second plant within the outer body.

19. The method of claim 14, wherein installing the outer body further includes at least partially burying the outer body in a ground material that is not conducive to the growth of plants.

20. The method of claim 19, wherein installing the outer body further includes at least partially burying the outer body in one of soil, gravel, or rocks.
